(19) United States
(12) Patent Application Publication
(10) Pub. No.: US 2005/0134873 A1
(43) Pub. Date: Jun. 23, 2005

(54) Post screening handling of multibit raster operations

(76) Inventors: Santhosh Kumar T.N., Thrissur (IN); Gouresh Govind Kamat, Bangalore (IN)

Correspondence Address: TEXAS INSTRUMENTS INCORPORATED, P O BOX 655474, M/S 3999, DALLAS, TX, 75265, US

(21) Appl. No.: 10/739,479

(22) Filed: Dec. 18, 2003

(51) Int. Cl. H04N 1/405; H04N 1/52

(52) U.S. Cl. 358/1.9; 358/3.06; 358/536

(57) ABSTRACT

Upon rendering a raster operation when processing page data in page description language, logical operations in raster operations (ROPS) are replaced with arithmetic operations. All raster operations can be expressed as one or more logical operations between the source, destination and texture. The minimum value of A and B is substituted for A AND B. The maximum value of A and B is substituted for A OR B. The arithmetic operation of 2^{N}−1−A is substitutes for NOT A, N is the device independent pixel bit depth. The arithmetic operation A−B is substitutes for A XOR B. These substitutions preserve the intended meaning of the raster operation upon screening to the device pixel bit depth.

### TECHNICAL FIELD OF THE INVENTION

The technical field of this invention is raster operations in a print controller.

### BACKGROUND OF THE INVENTION

When printing a document, the page to be printed is typically composed electronically using software like QuarkXpress, Framemaker, etc. Internally the page is stored in a vector based graphical representation by these composition tools. This representation is then usually converted to another representation called a page description language (PDL). Some composition tools generate the PDL directly. To print the page, the PDL representation is sent to the printer. Before display or printing, a raster image processor (RIP) converts the PDL representation of the page to a raster (bitmap) representation at the desired resolution.

This conversion process can usually be divided into two stages: interpretation and rendering. Interpretation reduces the original page description to a series of drawing primitives called the display list. Rendering converts these drawing primitives into a bitmap in the frame buffer.

The rendering engine usually generates the bitmap representation of the page to be printed in a device independent format with a pixel depth of 8 bits. Since the print engines have variable pixel depths depending on the quality required, the bitmap has to be processed to match the print engine's resolution, usually one, two or four bits.

Printers are usually binary devices, the output on the paper either has ink or it does not. In order to print a continuous tone image, a technique called screening or halftoning is employed. In prior art, non-electronic printers a physical screen was employed to break up the picture into a plurality of small areas. Continuous tones were simulated by either controlling the size of a single ink dot within each screen opening, or by using a fine screen, and dedicating multiple openings to each visible dot. In the case of a 4 bit resolution printer, a 4 by 4 block was used, with the appropriate number of screen openings having ink to match the input binary value. With a 4 by 4 block, 16 gray scale values were possible. This process is also called halftoning or dithering. In a fully electronic printer, software performs the screening or halftoning. In printing large gray levels of the input picture have to be simulated by the printing device to reproduce the original image. However, in the printed image the pixel resolution can be limited to that which is perceivable by the eye. Hence by grouping the adjacent pixels it is possible to simulate a continuous tone in the image.

### SUMMARY OF THE INVENTION

Upon rendering a raster operation when processing page data in page description language, logical operations in raster operations (ROPS) are replaced with arithmetic operations. The minimum value of A and B is substituted for A AND B. The maximum value of A and B is substituted for A OR B. The arithmetic operation of 2^{N}−1−A is substitutes for NOT A, where N is the device independent pixel bit depth. The arithmetic operation S−B is substitutes for A XOR B. These substitutions preserve the intended meaning of the raster operation upon screening or halftoning to the device pixel bit depth. For example, this invention preserves compatibility between a computer monitor output and any halftoning or screening method used in printing for various read bits per pixel for halftone or halftone cell.

### BRIEF DESCRIPTION OF THE DRAWINGS

These and other aspects of this invention are illustrated in the drawings, in which:

FIG. 1 illustrates in block diagram form a print controller for a networked printer to which this invention is applicable;

FIG. 2 illustrates the steps in the raster image process performed by the print controller illustrated in FIG. 1;

FIG. 3 illustrates schematically the data processing in raster operations; and

FIG. 4 illustrates the steps in the raster image process performed by the print controller according to this invention showing substitution of arithmetic operations for logical operations.

### DETAILED DESCRIPTION OF PREFERRED EMBODIMENTS

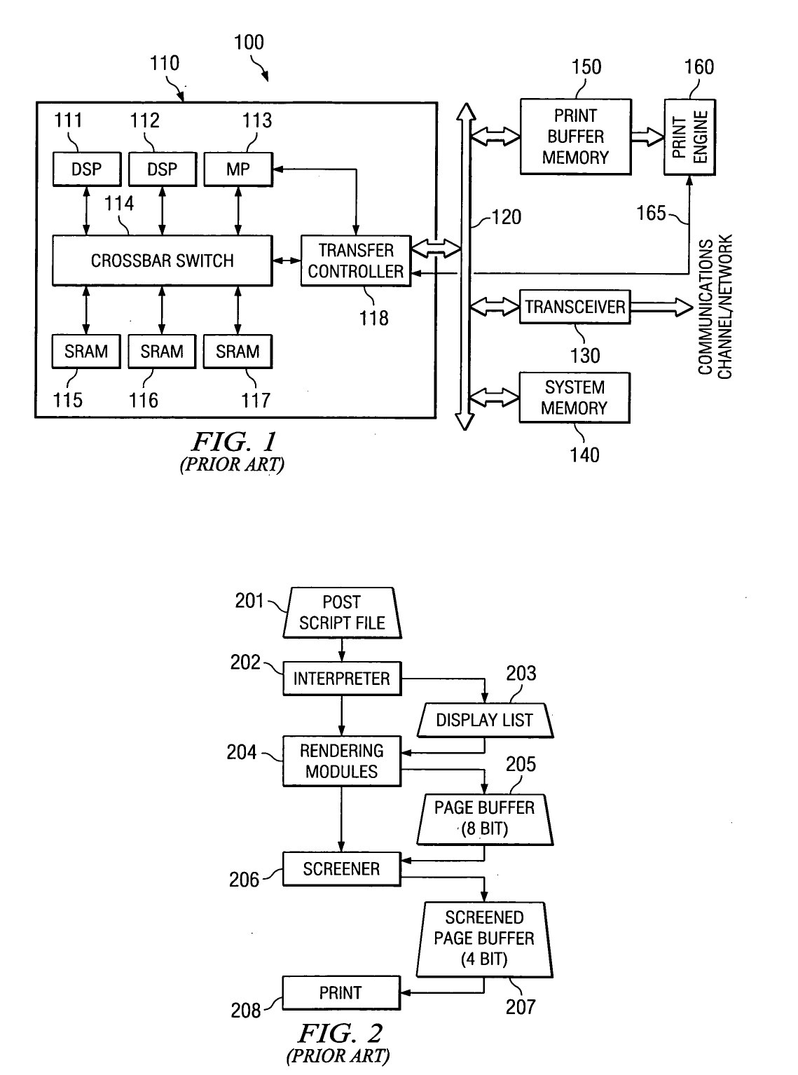

FIG. 1 is a block diagram of a network printer system 100 including a microprocessor 110 constructed for image and graphics processing according to this invention. Microprocessor 110 provides the data processing including data manipulation and computation for image operations of the network printer system 100. Microprocessor 110 is bi-directionally coupled to a system bus 120.

Network printer system 100 includes transceiver 130. Transceiver 130 provides translation and bidirectional communication between system bus 120 and a communications channel. One example of a system employing transceiver 130 is a local area network. Network printer system 100 responds to print requests received via the communications channel of the local area network. Microprocessor 110 provides translation of print jobs specified in a page description language, such as PostScript, into data and control signals for printing.

Network printer system 100 includes a system memory 140 coupled to system bus 120. System memory 140 may include video random access memory, dynamic random access memory, static random access memory, nonvolatile memory such as EPROM, FLASH or read only memory or a combination of these memory types. Microprocessor 110 may be controlled either in wholly or partially by a program stored in system memory 140. System memory 140 may also store various types of graphic image data.

Microprocessor 110 communicates with print buffer memory 150 for specification of a printable image via a pixel or bit map. Microprocessor 110 controls the image data stored in print buffer memory 150 via system bus 120. Data corresponding to this image is recalled from print buffer memory 150 and supplied to print engine 160. Print engine 160 provides the mechanism that places color dots on the printed page. Print engine 160 is further responsive to control signals from microprocessor 110 for paper and print head control. Microprocessor 110 determines and controls where print information is stored in print buffer memory 150. Subsequently, during readout from print buffer memory 150, microprocessor 110 determines the readout sequence from print buffer memory 150, the addresses to be accessed, and control information needed to produce the desired printed image by print engine 160.

Microprocessor 110 may be embodied by a Texas Instruments TMS320C82 digital signal processor (DSP). FIG. 1 illustrates the basic architecture of this digital signal processor. The TMS320C82 is a single integrated circuit multiprocessor. This integrated circuit is a fully programmable parallel processing platform that integrates two digital signal processors (DSP) 111 and 112, a reduced instruction set computer (RISC) master processor (MP) 113, multiple static random access memory (SRAM) blocks 115, 116 and 117, a crossbar switch 114 that interconnects all the internal processors and memories, and a transfer controller 118 that controls external communications. Transfer controller 118 is coupled to system bus 120. Note that transfer controller 118 controls all data transfer between microprocessor 110 and other structured coupled to system bus 120. Image data may be stored in system memory 140.

In operation, the individual digital signal processors 111 and 112 operate independently to transform page description data received via transceiver 130 into a corresponding page bit map data. This transformation includes the raster operations that are the subject of this invention. This page bit map data is stored in print buffer memory 150 for supply to print engine 160. Each digital signal processor 111 and 112 signals transfer controller 118 to transfer data from system memory 140 to the corresponding SRAM 115 and 116. During this page transformation operation digital signal processors 111 and 112 may use portions of the corresponding SRAM 115 and 116 for intermediate data. Digital signal processors 111 and 112 perform a programmed image transformation function on data in place in the corresponding SRAMs 115 and 116. The program for control of this page transformation is preferably stored in a non-volatile portion of system memory 140. Access by digital signal processors 111 and 112 and master processor 113 to SRAMs 115, 116 and 117 is mediated by crossbar switch 114. When complete, digital signal processors 111 and 112 signal transfer controller 118 to transfer data to print buffer memory 150. Transfer controller 118 preferably also includes a control channel 165 to print engine 160. Control channel 165 enables control of print functions by microprocessor 110. Master processor 113 is preferably programmed for high level functions such as communication control functions not relevant to this invention.

Note that this description of the TMS320C82 is merely an example. Any microprocessor with sufficient computation capacity could be used. This print controller application would be best served by a microprocessor with sufficient computational capacity to perform the data processing function as fast as print engine 160 can print the page. However, it is possible to perform the data processing functions and store the results a memory. This stored results may then be supplied to print engine 160 from the memory.

FIG. 2 illustrates the steps typically executed when a document specified in a page description language, such as PostScript, is to be printed. Following receipt of the print file (input data file 201) is interpretation (processing block 202). In this step, the input page description language file is interpreted and converted into an intermediate form called the display list (data file 203). The display list 203 consists of a list of low level graphics primitives such as trapezoids, fonts, images, etc. that make up the described page. Next the display list 203 is rendered (processing block 204). Each element in the display list 203 is processed in this step and the output is written into a buffer known as the page buffer (data file 205). The page buffer 205 represents a portion of the output image for a particular color plane. In the page buffer 205, each pixel is typically represented by 8 bits. After all the elements in display list 203 have been processed, page buffer 205 contains the output image in an 8 bit format.

Next the page buffer is screened (processing block 206). The resolution supported by the printing device may be anywhere between 1 to 8 bits per pixel. FIG. 2 illustrates an example yielding 4 bits per pixel. Page buffer 205 developed in the rendering step 204 has to be converted into the resolution supported by the printer. The thus converted data is called the device image. Each pixel in page buffer 205 has to be converted to its corresponding device pixel value. For instance, in the case of a 4 bit device pixel, each pixel in page buffer 205 has to be converted to a 4 bit value. This screening process results in a screened page buffer (data file 207). Next comes printing (processing block 208). Each pixel in the screened page buffer 207 is printed on the paper. This process is repeated for all the color planes, such as cyan, yellow, magenta and black.

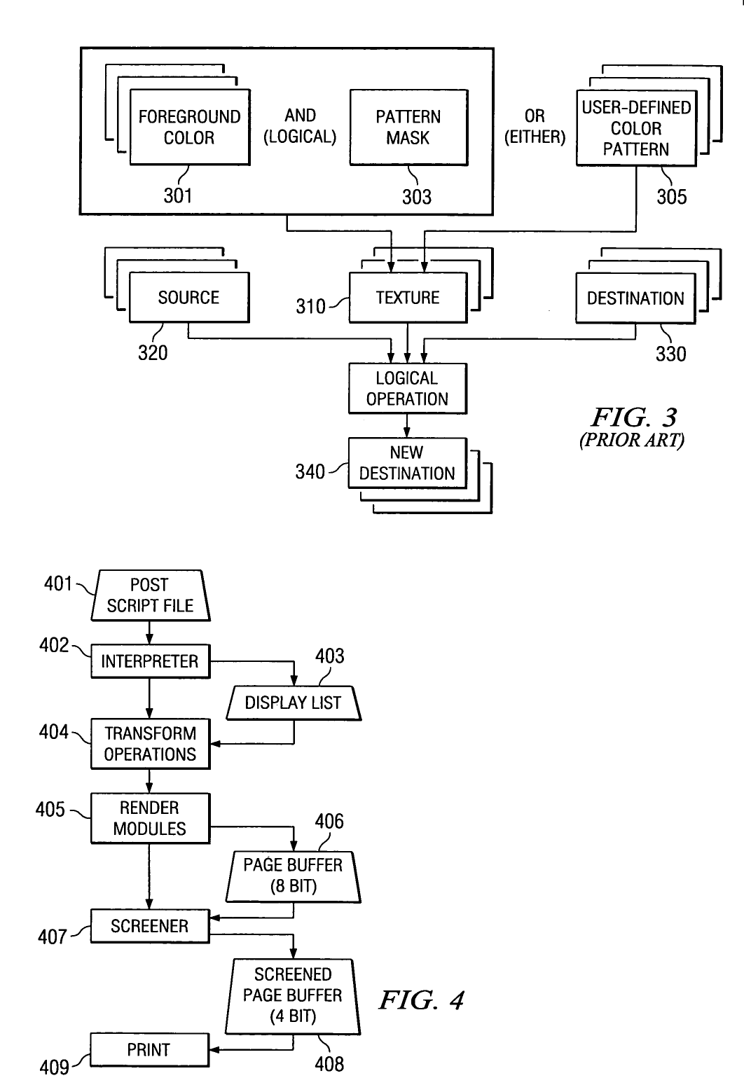

FIG. 3 illustrates a raster operation schematically. Raster operations combine images in ways mimicking real world operations. FIG. 3 shows a combination of a texture plane 310 with a source image 320 and a destination image 330 to form a new destination image 340. The texture plane 310 can be formed from a foreground color 301 and a pattern mask 303. The foreground color 301 is a single color combined with the pattern mask 303. The pixels of pattern mask 303 paint through the non-white pixels of source image onto the destination image. Texture 310 may alternatively be specified by user-defined color pattern 305. Source image 320 is an image for which the non-white pixels are replaced by texture 310. Source image 320 functions like a stencil through which the texture plane 310 is applied to the destination image. Destination image 330 is modified by the source image/texture combination to form the new destination 340. Various transparency modes can be employed in a manner not relevant to this invention.

In general there are 255 possible logical operations between pixels in the texture plane 310, source image 320 and destination image 330. The 255 possible logical operations are listed below in Table 1 as defined by Microsoft ROP3. Each raster operation is a Boolean operation of the values of the pixels in texture plane 310, source image 320 and destination image 330. Table 1 uses the following definitions: D is the value of the destination pixel; T is the value of the corresponding texture pixel; S is the value of the corresponding source pixel. The operations are defined as follows: a is bitwise AND; n is bitwise NOT or inverse; o is bitwise OR; and x is bitwise exclusive OR.

These Boolean operations are presented in reverse Polish notation. The operation code is parsed from left to right. Each data value is pushed onto the top of a data stack, pushing any previously entered data down the stack. The binary operations (AND, OR, XOR) are performed on the top two elements of the stack. The result replaces these top two elements at the top of the stack. Other data is popped up one element. The unary operation NOT is performed on the value at the top of the stack. The result replaces the prior value at the top of the stack. No other data values are moved. The most commonly used raster operations have short hand names listed in Table 1.

TABLE 1

| Function | Boolean function |
|---|---|
| Number | in reverse Polish |
| 0 | 0 |
| 1 | DTSoon |
| 2 | DTSona |
| 3 | TSon |
| 4 | SDTona |
| 5 | DTon |
| 6 | TDSxnon |
| 7 | TDSaon |
| 8 | SDTnaa |
| 9 | TDSxon |
| 10 | DTna |
| 11 | TSDnaon |
| 12 | STna |
| 13 | TDSnaon |
| 14 | TDSonon |
| 15 | Tn |
| 16 | TDSona |
| 17 | DSon |
| 18 | SDTxnon |
| 19 | SDTaon |
| 20 | DTSxnon |
| 21 | DTSaon |
| 22 | TSDTSanaxx |
| 23 | SSTxDSxaxn |
| 24 | STxTDxa |
| 25 | SDTSanaxn |
| 26 | TDSTaox |
| 27 | SDTSxaxn |
| 28 | TSDTaox |
| 29 | DSTDxaxn |
| 30 | TDSox |
| 31 | TDSoan |
| 32 | DTSnaa |
| 33 | SDTxon |
| 34 | DSna |
| 35 | STDnaon |
| 36 | STxDSxa |
| 37 | TDSTanaxn |
| 38 | SDTSaox |
| 39 | SDTSxnox |
| 40 | DTSxa |
| 41 | TSDTSaoxxn |
| 42 | DTSana |
| 43 | SSTxTDxaxn |
| 44 | STDSoax |
| 45 | TSDnox |
| 46 | TSDTxox |
| 47 | TSDnoan |
| 48 | TSna |
| 49 | SDTnaon |
| 50 | SDTSoox |
| 51 | Sn |
| 52 | STDSaox |
| 53 | STDSxnox |
| 54 | SDTox |
| 55 | SDToan |
| 56 | TSDToax |
| 57 | STDnox |
| 58 | STDSxox |
| 59 | STDnoan |
| 60 | TSx |
| 61 | STDSonox |
| 62 | STDSnaox |
| 63 | TSan |
| 64 | TSDnaa |
| 65 | DTSxon |
| 66 | SDxTDxa |
| 67 | STDSanaxn |
| 68 | SDna |
| 69 | DTSnaon |
| 70 | DSTDaox |
| 71 | TSDTxaxn |
| 72 | SDTxa |
| 73 | TDSTDaoxxn |
| 74 | DTSDoax |
| 75 | TDSnox |
| 76 | SDTana |
| 77 | SSTxDSxoxn |
| 78 | TDSTxox |
| 79 | TDSnoan |
| 80 | TDna |
| 81 | DSTnaon |
| 82 | DTSDaox |
| 83 | STDSxaxn |
| 84 | DTSonon |
| 85 | Dn |
| 86 | DTSox |
| 87 | DTSoan |
| 88 | TDSToax |
| 89 | DTSnox |
| 90 | DTx |
| 91 | DTSDonox |
| 92 | DTSDxox |
| 93 | DTSnoan |
| 94 | DTSDnaox |
| 95 | DTan |
| 96 | TDSxa |
| 97 | DSTDSaoxxn |
| 98 | DSTDoax |
| 99 | SDTnox |
| 100 | SDTSoax |
| 101 | DSTnox |
| 102 | DSx |
| 103 | SDTSonox |
| 104 | DSTDSonoxxn |
| 105 | TDSxxn |
| 106 | DTSax |
| 107 | TSDTSoaxxn |
| 108 | SDTax |
| 109 | TDSTDoaxxn |
| 110 | SDTSnoax |
| 111 | TDSxnan |
| 112 | TDSana |
| 113 | SSDxTDxaxn |
| 114 | SDTSxox |
| 115 | SDTnoan |
| 116 | DSTDxox |
| 117 | DSTnoan |
| 118 | SDTSnaox |
| 119 | DSan |
| 120 | TDSax |
| 121 | DSTDSoaxxn |
| 122 | DTSDnoax |
| 123 | SDTxnan |
| 124 | STDSnoax |
| 125 | DTSxnan |
| 126 | STxDSxo |
| 127 | DTSaan |
| 128 | DTSaa |
| 129 | STxDSxon |
| 130 | DTSxna |
| 131 | STDSnoaxn |
| 132 | SDTxna |
| 133 | TDSTnoaxn |
| 134 | DSTDSoaxx |
| 135 | TDSaxn |
| 136 | DSa |
| 137 | SDTSnaoxn |
| 138 | DSTnoa |
| 139 | DSTDxoxn |
| 140 | SDTnoa |
| 141 | SDTSxoxn |
| 142 | SSDxTDxax |
| 143 | TDSanan |
| 144 | TDSxna |
| 145 | SDTSnoaxn |
| 146 | DTSDToaxx |
| 147 | STDaxn |
| 148 | TSDTSoaxx |
| 149 | DTSaxn |
| 150 | DTSxx |
| 151 | TSDTSonoxx |
| 152 | SDTSonoxn |
| 153 | DSxn |
| 154 | DTSnax |
| 155 | SDTSoaxn |
| 156 | STDnax |
| 157 | DSTDoaxn |
| 158 | DSTDSaoxx |
| 159 | TDSxan |
| 160 | DTa |
| 161 | TDSTnaoxn |
| 162 | DTSnoa |
| 163 | DTSDxoxn |
| 164 | TDSTonoxn |
| 165 | TDxn |
| 166 | DSTnax |
| 167 | TDSToaxn |
| 168 | DTSoa |
| 169 | DTSoxn |
| 170 | D |
| 171 | DTSono |
| 172 | STDSxax |
| 173 | DTSDaoxn |
| 174 | DSTnao |
| 175 | DTno |
| 176 | TDSnoa |
| 177 | TDSTxoxn |
| 178 | SSTxDSxox |
| 179 | SDTanan |
| 180 | TSDnax |
| 181 | DTSDoaxn |
| 182 | DTSDTaoxx |
| 183 | SDTxan |
| 184 | TSDTxax |
| 185 | DSTDaoxn |
| 186 | DTSnao |
| 187 | DSno |
| 188 | STDSanax |
| 189 | SDxTDxan |
| 190 | DTSxo |
| 191 | DTSano |
| 192 | TSa |
| 193 | STDSnaoxn |
| 194 | STDSonoxn |
| 195 | TSxn |
| 196 | STDnoa |
| 197 | STDSxoxn |
| 198 | SDTnax |
| 199 | TSDToaxn |
| 200 | SDToa |
| 201 | STDoxn |
| 202 | DTSDxax |
| 203 | STDSaoxn |
| 204 | S |
| 205 | SDTono |
| 206 | SDTnao |
| 207 | STno |
| 208 | TSDnoa |
| 209 | TSDTxoxn |
| 210 | TDSnax |
| 211 | STDSoaxn |
| 212 | SSTxTDxax |
| 213 | DTSanan |
| 214 | TSDTSaoxx |
| 215 | DTSxan |
| 216 | TDSTxax |
| 217 | SDTSaoxn |
| 218 | DTSDanax |
| 219 | STxDSxan |
| 220 | STDnao |
| 221 | SDno |
| 222 | SDTxo |
| 223 | SDTano |
| 224 | TDSoa |
| 225 | TDSoxn |
| 226 | DSTDxax |
| 227 | TSDTaoxn |
| 228 | SDTSxax |
| 229 | TDSTaoxn |
| 230 | SDTSanax |
| 231 | STxTDxan |
| 232 | SSTxDSxax |
| 233 | DSTDSanaxxn |
| 234 | DTSao |
| 235 | DTSxno |
| 236 | SDTao |
| 237 | SDTxno |
| 238 | DSo |
| 239 | SDTnoo |
| 240 | T |
| 241 | TDSono |
| 242 | TDSnao |
| 243 | TSno |
| 244 | TSDnao |
| 245 | TDno |
| 246 | TDSxo |
| 247 | TDSano |
| 248 | TDSao |
| 249 | TDSxno |
| 250 | DTo |
| 251 | DTSnoo |
| 252 | TSo |
| 253 | TSDnoo |
| 254 | DTSoo |
| 255 | 1 |

It is typical to perform the rendering step 204 (FIG. 2) at a device independent pixel depth of 8 bits per color plane. The resolution following screening (step 206) is variable dependent on the display device or print engine. This pixel depth is generally 1 bit, 2 bits, 4 bits or 8 bits per pixel per color plane.

Performing a raster operation after screening presents a problem. The varying color bit depth produces different results. Consider the example of a raster operation AND of a source and a destination with the paint value being inconsequential. In this example the gray scale value of one source pixel is hex 7F and gray scale value of the corresponding destination pixel is hex 80. If this is screened to an 8-bit color bit depth, then Table 2 shows the result for this pixel using an AND operation.

TABLE 2

| Pixel | Value |
|---|---|
| Source | 0 1 1 1 1 1 1 1 |
| Destination | 1 0 0 0 0 0 0 0 |
| Result (AND) | 0 0 0 0 0 0 0 0 |

Thus for an 8-bit system the result of the raster operation is hex 00. Suppose these pixel values had been screened to 1 bit per color plane. In a 1-bit system after screening the 8-bit gray scale value of hex 7F would be represented by a 16 by 16 pixel block with 127 pixels ON and the rest OFF. Similarly, the 8-bit gray scale value of hex 80 would be represented by the same block with 128 pixels ON. Applying an AND operation to the 256 1-bit values would result in a raster operation screened value of 127 or hex 7F. So the raster operation results in different values dependent upon the color bit depth.

This invention remedies this different by proposing substitute operations for the raster operations. The normal processing order is render, screen and raster operation. The example above illustrates differing results dependent upon the pixel bit depth of the screen pixels. This invention proposes to change the processing order to render, raster operation, then screen. The raster operation at the device independent pixel level is altered to produce the desired result after screening. Table 3 shows the original logical raster operations and the proposed substitute arithmetic operations. In Table 3: S is the source pixel value; D is the destination pixel value; and N is the device independent color bit depth before screening.

TABLE 3

| Logical Operation | Substitute Operation |
|---|---|
| AND(A, B) | MIN(A, B) |
| OR(A, B) | MAX(A, B) |
| NOT(A) | 2^{N} − 1 − A |
| XOR(A, B) | A − B |

This technique provides comparable results regardless of the color bit depth of the screened output. This causes the results of the raster operation to appear similar when viewed on a display screen or printed on devices having differing color bit depth.

FIG. 4 illustrates the steps of this invention. This is similar to FIG. 2. Following receipt of the print file (input data file 401) is interpretation (processing block 402). The input page description language file is interpreted and converted into an intermediate form called the display list (data file 403). All the logical operations defining any raster operations within the display list are transformed into the corresponding arithmetic operations (processing block 404) according to Table 3. Next the display list 403 is rendered (processing block 405). Each element in the display list 403 is processed in this step and the output is written into a buffer known as the page buffer (data file 405). As a part of this rendering, the process employs the substituted arithmetic operations for logical operations in any raster operations. Next the page buffer is screened (processing block 407). The resolution supported by the printing device may be anywhere between 1 to 8 bits per pixel. FIG. 4 illustrates an example yielding 4 bits per pixel. Page buffer 408 is converted into the resolution supported by the printer. This screening process results in a screened page buffer (data file 408). Next comes printing (processing block 409). Each pixel in the screened page buffer 408 is printed on the paper. This process is repeated for all the color planes, such as cyan, yellow, magenta and black.

1. A method of printing comprising:
receiving page data corresponding to a page to be printed in a page description language including at least one raster operation;
interpreting the page data into a display list of elements to be printed;
rendering the display list into a pixel map having a device independent pixel bit depth, wherein rendering a raster operation includes substituting for at least one logic raster operation a corresponding arithmetic operation;
screening the pixel map having the device dependent pixel bit depth into a pixel map having a pixel bit depth corresponding to a print engine; and
supplying the pixel map having a pixel bit depth corresponding to the print engine to the print engine for printing.

2. The method of claim 1, wherein:
said at least one logic raster operation includes the logical A AND B, where A and B are pixel values; and
said corresponding arithmetic operation is the minimum pixel value of A and B.

3. The method of claim 1, wherein:
said at least one logic raster operation includes the logical A OR B, where A and B are pixel values; and
said corresponding arithmetic operation is the maximum value of A and B.

4. The method of claim 1, wherein:
said at least one logic raster operation includes the logical NOT A, where A is a pixel value; and
said corresponding arithmetic operation is the 2^{N}−1−A, where N is the device independent pixel bit depth.

5. The method of claim 1, wherein:
said at least one logic raster operation includes the logical A XOR B, where A and B are pixel values; and
said corresponding arithmetic operation is A−B.

6. The method of claim 1, wherein:
expressing all raster operations as combinations of the logical operations AND, OR, NOT and XOR between respective pixel values for a corresponding source pixel, destination pixel and texture pixel; and
said step of substituting for at least one logic raster operation a corresponding arithmetic operation includes
substituting the minimum of A and B for the logical operation A AND B,
substituting the maximum of A and B for the logical operation A OR B,
substituting 2^{N}−1−A, where N is the device independent pixel bit depth, for the logical operation NOT A, and
substituting A−B for the logical operation A XOR B.

7. A printer comprising:
a transceiver adapted for bidirectional communication with a communications channel;
a memory;
a print engine adapted for placing color dots on a printed page according to received page bit map data and control signals; and
a programmable data processor connected to said transceiver, said memory and said print engine, said programmable data processor programmed to:
receive page data corresponding to a page to be printed in a page description language including at least one raster operation,
interpret the page data into a display list of elements to be printed,
render the display list into a pixel map having a device independent pixel bit depth, wherein rendering a raster operation includes substituting for at least one logic raster operation a corresponding arithmetic operation,
screen the pixel map having the device dependent pixel bit depth into a pixel map having a pixel bit depth corresponding to a print engine, and
transmit the pixel map having a pixel bit depth corresponding to the print engine to the print engine for printing.

8. The printer of claim 7, wherein:
said programmable data processor is further programmed to:
perform an arithmetic operation of the minimum value of A and B as a substitute for the logical raster logical operation of A AND B, where A is the value of a source pixel and B is the value of a corresponding destination pixel.

9. The printer of claim 7, wherein:
said programmable data processor is further programmed to:
perform an arithmetic operation of the maximum value of A and B as a substitute for the logical raster operation of A OR B, where A is the value of a source pixel and B is the value of a corresponding destination pixel.

10. The printer of claim 7, wherein:
said programmable data processor is further programmed to:
perform an arithmetic operation of 2^{N}−1−A as a substitute for the logical raster operation of NOT A, where A is the value of a source pixel and N is the device independent pixel bit depth.

11. The printer of claim 7, wherein:
said programmable data processor is further programmed to:
perform an arithmetic operation is A−B as a substitute for the logical raster operation of the A XOR B, where A is the value of a source pixel and B is the value of a corresponding destination pixel.

12. The printer of claim 7, wherein:
said programmable data processor is further programmed to:
express all raster operations as combinations of the logical operations AND, OR, NOT and XOR between respective pixel values for a corresponding source pixel, destination pixel and texture pixel,
perform the minimum of A and B as a substitute for the logical operation A AND B,
perform the maximum of A and B as a substitute for the logical operation A OR B,
perform 2^{N}−1−A, where N is the device independent pixel bit depth, as a substitute for the logical operation NOT A, and
perform A−B as a substitute for the logical operation A XOR B.
